(19) United States
(12) Patent Application Publication
(10) Pub. No.: US 2016/0170416 A1
(43) Pub. Date: Jun. 16, 2016

(54) FLYING APPARATUS AND METHOD OF REMOTELY CONTROLLING A FLYING APPARATUS USING THE SAME

(71) Applicant: PEGATRON CORPORATION, Taipei City (TW)

(72) Inventors: Yu-Chang Chen, TAIPEI CITY (TW); Hao-Yung Chang, TAIPEI CITY (TW); Tao-Hua Cheng, TAIPEI CITY (TW)

(21) Appl. No.: 14/970,680

(22) Filed: Dec. 16, 2015

(30) Foreign Application Priority Data
Dec. 16, 2014 (TW) 103143929

(51) Int. Cl. G05D 1/10; B64D 47/08; B64C 39/02; B64C 27/08; B64C 27/20

(52) U.S. Cl. CPC G05D 1/101; B64C 27/08; B64C 27/20; B64C 39/024; B64D 47/08; B64C 2201/141

(57) ABSTRACT

The flying apparatus of the invention includes a main body, a first distance sensor and a second distance sensor. The first distance sensor and the second distance sensor are disposed at the bottom surface and the top surface of the main body, respectively. Moreover, the main body has a processing module that can receive the sensed signal outputted from the first distance sensor or the second distance sensor and output a displacement signal according to the content of the first sensed signal. When the relative distance between the first distance sensor and the sensed object is shorter than a default reception distance, the first distance sensor outputs the first sensed signal. When the relative distance between the second distance sensor and the sensed object is shorter than the default reception distance, the second distance sensor outputs the first sensed signal. The main body also has a flight driving module that receives the displacement signal and increases or decreases the height of the flying apparatus according to the displacement signal.

### BACKGROUND

1. Technology Field

The disclosure relates to a flying apparatus and a method of remotely controlling a flying apparatus and, in particular, to a flying apparatus and a method of remotely controlling a flying apparatus having a motion-sensing function.

2. Related Art

Common flying apparatuses include the helicopter-type flying apparatus and the multi-rotor-type flying apparatus. The former has a main rotor at the top to provide the lift force and a tail rotor at the tail to counter the torque. The latter has multiple rotors at the top with different rotation directions to balance torque, and can fly toward different directions by changing the rotation speeds.

Along with the compactness and lightweight, a multi-rotor flying apparatus can be carried by a user easily to conduct aerial surveillance, aerial photography and terrain exploration missions. However, a current flying apparatuses needs a remote controller or an application programs installed on a mobile device as the control interface. The operating items of the user interface are complex, and a user needs more time to learn and adapt to the operations to maintain a better coordination between different operating items. Furthermore, the operation of a remote controller or a mobile device requires highly focus of the user, which limits the activity of the user and makes it difficult for the user to take into account of other tasks. Therefore, how to reduce the limitation to the user and to simplify the operations effectively has become an urgent issue to be solved.

### SUMMARY

An objective of the invention is to provide a flying apparatus that can move according to the body movement of the user.

Another objective of the invention is to provide a method of remotely controlling a flying apparatus that can simplify the complexity to operate the flying apparatus.

In one embodiment, the invention provides a flying apparatus, which includes a main body, a first distance sensor and a second distance sensor. The first distance sensor and the second distance sensor are disposed at the bottom surface and the top surface of the main body, respectively. Moreover, the main body has a processing module that can receive the sensed signal outputted from the first distance sensor or the second distance sensor and output a displacement signal according to the content of the first sensed signal. When the relative distance between the first distance sensor and the sensed object is shorter than a default reception distance, the first distance sensor outputs the first sensed signal. When the relative distance between the second distance sensor and the sensed object is shorter than the default reception distance, the second distance sensor outputs the first sensed signal. The main body also has a flight driving module that receives the displacement signal and increases or decreases the height of the flying apparatus according to the displacement signal.

In one embodiment, the invention provides a method of remotely controlling a flying apparatus, including the following steps: obtaining a relative distance between the first distance sensor and the sensed object by the first distance sensor; comparing the relative distance with a default reception distance; entering into a first reading mode if the relative distance is shorter than or equal to the default reception distance, wherein in the first reading mode the first distance sensor performs height positioning and motion sensing, the first camera unit performs horizontal positioning; and entering into the second reading mode if the relative distance is longer than the default reception distance, wherein in the second reading mode the first distance sensor performs height positioning, the first camera unit performs horizontal positioning and motion sensing. With the method of remotely controlling a flying apparatus of the invention, the operation of the flying apparatus can be performed in different ways according to the relative position of the sensed object to the first distance sensor or the second distance sensor.

### BRIEF DESCRIPTION OF THE DRAWINGS

FIG. 1A is a perspective diagram of the flying apparatus according to an embodiment of the invention viewing from the top.

FIG. 1B is a perspective diagram of the flying apparatus according to an embodiment of the invention viewing from the bottom.

FIG. 2A and FIG. 2B are partial enlarged views of the rotatable part of the flying apparatus.

FIG. 3 is a top view of the flying apparatus according to another embodiment of the invention.

FIG. 4 is a block diagram of the flying apparatus according to an embodiment of the invention.

FIG. 5 is a schematic diagram showing spatial positioning of the flying apparatus according to an embodiment of the invention.

FIG. 6A to FIG. 6C are schematic diagrams showing the operation of the flying apparatus according to an embodiment of the invention.

FIG. 7 is a flowchart of the method of remotely controlling a flying apparatus according to an embodiment of the invention.

FIG. 8 is a flowchart showing an embodiment of the first reading mode.

FIG. 9 is a flowchart showing an embodiment of the second reading mode.

FIG. 10A to FIG. 10C are schematic diagrams showing the operation of the flying apparatus according to another embodiment of the invention.

FIG. 11 is a flowchart showing the generation of the captured image by the method of remotely controlling a flying apparatus according to an embodiment of the invention.

FIG. 12 is a schematic diagram showing the generation of the captured image.

### DETAILED DESCRIPTION OF THE EMBODIMENT

The invention discloses a flying apparatus with motion-sensing function. In one embodiment, the flying apparatus may be a multi-rotor flying machine for indoor use, including a first distance sensor for height positioning and a first camera unit for horizontal positioning.

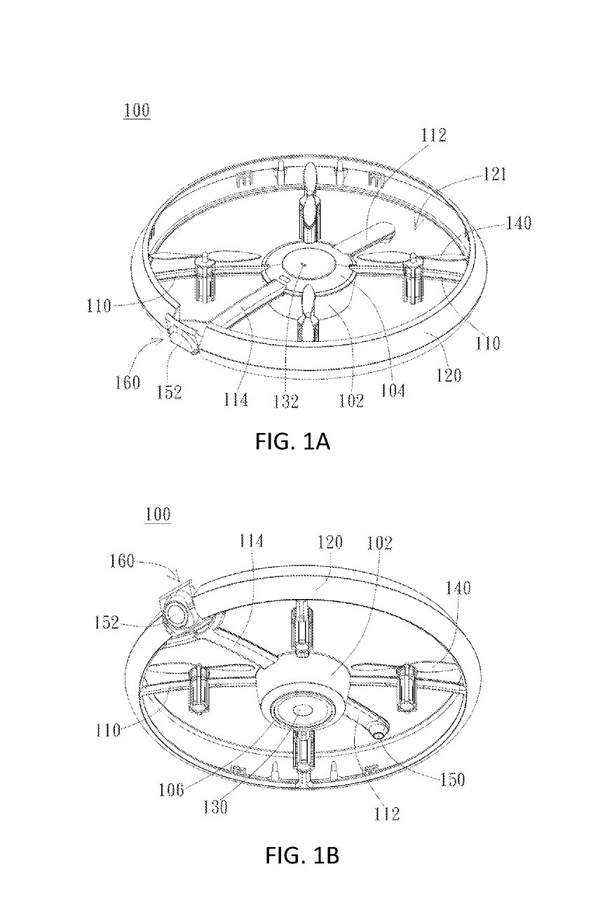

FIG. 1A is a perspective diagram of the flying apparatus 100 according to an embodiment of the invention viewing from the top. As shown in FIG. 1A, the flying apparatus 100 includes a main body 102, a plurality of first arms 110, an external housing 120 and a plurality of rotors 140. The first arms 110 are connected around the main body 102. One end of each of the first arms 110 is connected with the main body 102, and the first arms 110 are extended from the main body 102. The external housing 120 is disposed around the main body 102 and is connected with the first arms 110. The rotors 140 are disposed at each of the first arms 110 and are positioned inside the external housing 120. Specifically speaking, the external housing 120 surrounds to form a hollow space 121, and the main body 102 is disposed in the hollow space 121. The external housing 120 can protect the internal rotors 140 and the main body 102 from being damaged when the flying apparatus 100 is flying. Moreover, the end of each first arm 110 away from the main body 102 is connected with the external housing 120, and the first arms 110 are evenly distributed radially. For example, the first arms 110 may be disposed around the main body 102 in intervals by the same or similar angles according to the number of the first arms 110. As shown in FIG. 1A, the main body 102 has a top surface 104, and a second distance sensor 132 is disposed on the top surface 104. Correspondingly, a second distance sensor 132 is disposed on the bottom surface 106 of the main body 102 (referring to FIG. 1B). The distance sensors may be infrared sensors or laser receiving modules to perform wireless sensing.

FIG. 1B is a perspective diagram of the flying apparatus 100 according to an embodiment of the invention viewing from the bottom. As shown in FIG. 1B, except for being connected with the first arms 110, the main body 102 is further connected with a second arm 112 and a third arm 114. One end of the second arm 112 is connected with the main body 102 along the radial direction. A first camera unit 150 is disposed at the second arm 112 toward the direction of the bottom surface 106. In one embodiment, the second arm 112 is extended from the main body 102 and is positioned between two adjacent first arms 110. In another embodiment, the second arm 112 can be excluded in view of practical requirements and the first camera unit 150 can be disposed at the bottom surface 106 of the main body 102. Moreover, the third arm 114 is connected with the main body 102 at the side opposite to the second arm 112. By extending in the opposite direction to the second arm 112, the third arm 114 can maintain the balance of the overall structure. In this embodiment, the end of the third arm 114 away from the main body 102 is connected with the external housing 120, but it is not so limited. In other embodiments, the third arm 114 may be designed to be similar to the second arm that one end is connected with the main body 102 and the other end is suspended freely. The balance of the overall structure may also be maintained by altering the appearance of the main body 102 without disposing the third arm 114.

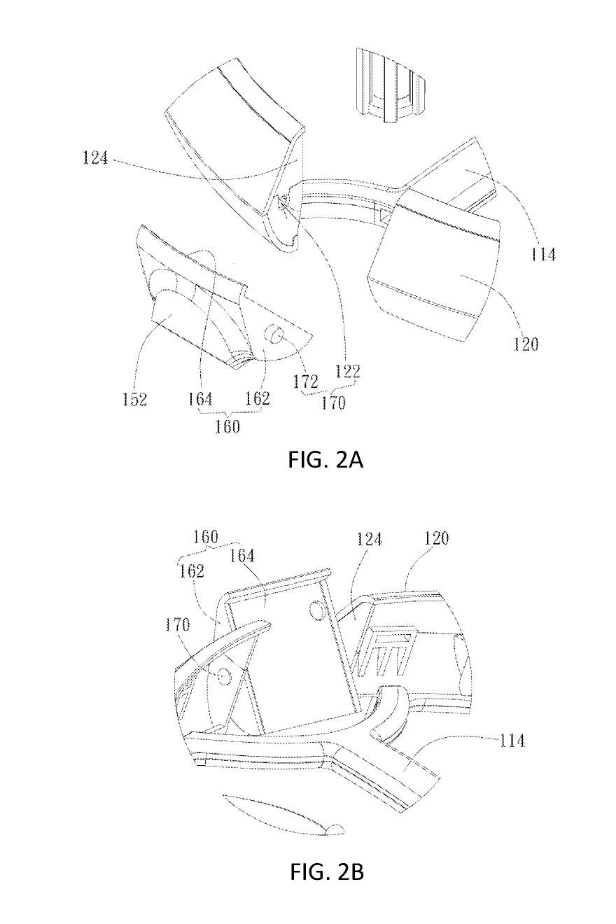

Furthermore, except for the first camera unit 150 mentioned above, as shown in FIG. 1A and FIG. 1B, a rotatable part 160 is disposed at the external housing and a second camera unit 152 is disposed at the rotatable part 160. Please also refer to FIG. 2A and FIG. 2B, which are partial enlarged views of the rotatable part of the flying apparatus. As shown in FIG. 2A, the rotatable part 160 has two side plates 162 and a connecting plate 164 connecting the two side plates 162. The second camera unit 152 is disposed at the outer surface of the connecting plate 164. The external housing 120 has sidewalls 124 corresponding to the position of the rotatable part 160. The surfaces of the two side plates 162 further have pivots 170 respectively so that the rotatable part 160 is rotatably connected with the side walls 124 of the external housing 120. As shown in FIG. 2A, the pivots 170 at the surface of the side plate 162 include pivot columns 172, and the side walls 124 of the external housing 120 have pivot holes 122 for being connected with the pivot columns 172. In other words, the projected pivot columns 172 extend into the pivot holes 122 along the tangential direction of the external housing 120 to complete the assembly of the rotatable part 160. In other embodiments, the pivot columns 172 mentioned above may be selectively disposed at the side walls 124 while the pivot holes 122 can be formed at the side plates 162. Please refer to FIG. 2B for the combination of the rotatable part 160 and the external housing 120. As shown in FIG. 2B, the rotatable part 160 is disposed at the external housing 120, and is rotatably adjustable between two side walls 124 via the pivots 170. That is, the rotatable part 160 is rotatable with the pivots 170 as the rotation axis. With this design, the rotatable part 160 becomes a rotatable portion of the external housing 120. Moreover, the second camera unit 152 can be rotated by the rotatable part 160 to shoot images at different angles. The user can pre-adjust the image-capturing angle before operating the flying apparatus, and rotate the second camera unit 152 to a specific angle.

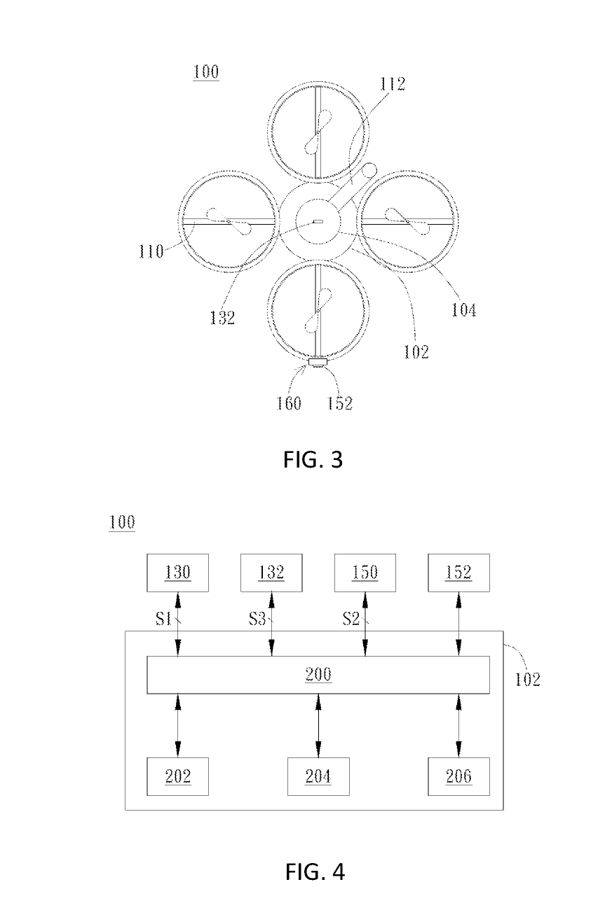

FIG. 3 is a top view of the flying apparatus 100 according to another embodiment of the invention. Compared with the previous embodiment, the flying apparatus 100 shown in FIG. 3 includes multiple external housings 120 surrounding the main body 102 to protect the rotors 140 and the main body 102. As shown in FIG. 3, one end of each of the first arms 110 are connected with the main body 102, and the first arms are disposed around the main body 102 in intervals by the same or similar angles. Each first arm 110 is disposed with a rotor 140 and an external housing 120, and the rotor 140 is within the external housing 120. The external housings 120 surround the main body 102. The first camera (not shown in the drawing) is disposed at the second arm 112 connected with the main body 102 in the same way mentioned previously. One of the external housings 120 has a rotatable part 160, and the second camera unit 152 is disposed at the rotatable part 160. By the design of multiple external housings 120, the internal rotors 140 and the main body 102 can be protected.

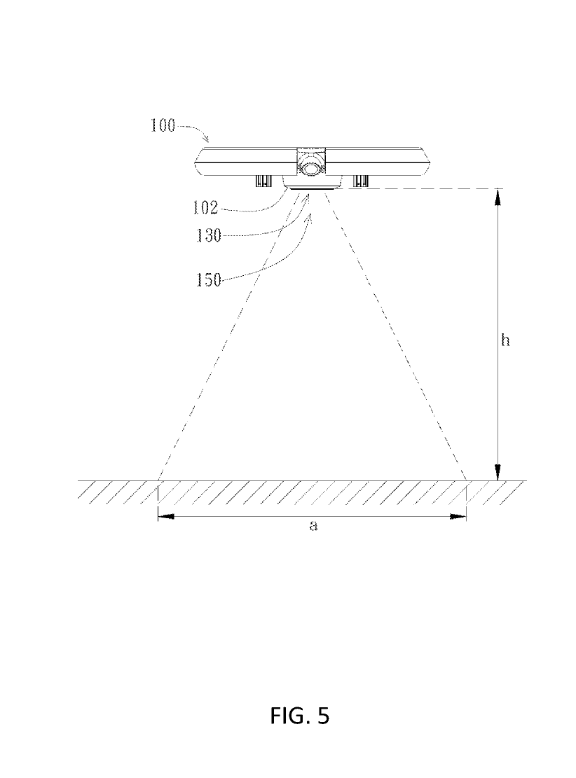

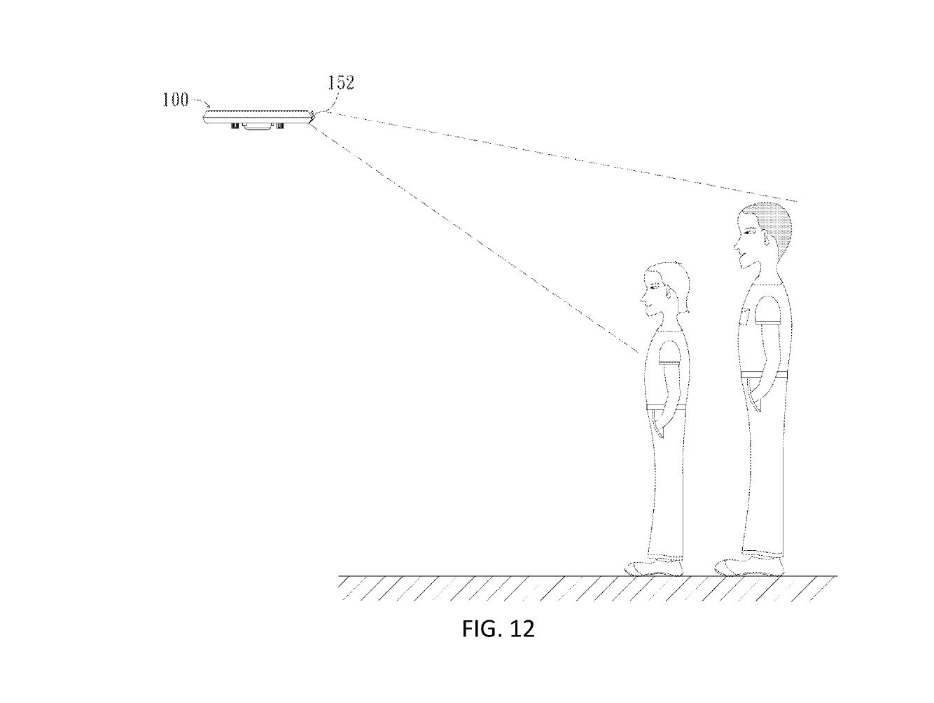

FIG. 4 is a block diagram of the flying apparatus according to an embodiment of the invention. As shown in FIG. 4, the main body 102 of the flying apparatus includes a processing module 200, a switching module 202, a flight driving module 204 and a storage module 206. The processing module 200 is coupled with the first distance sensor 130, the second distance sensor 132, the first camera unit 150 and the second camera unit 152 to perform signal exchanges. The switching module 202, the flight driving module 204 and the storage module 206 further process the signals from the distance sensors (130, 132) and the camera unit (150, 152) via the processing module 200. The detailed signal processing procedure with be explained hereinbelow with reference to FIG. 5˜FIG. 12.

As mentioned previously, the first distance sensor can perform height positioning, and the first camera unit can perform horizontal positioning. Please refer to FIG. 4 and FIG. 5. FIG. 5 is a schematic diagram showing the spatial positioning of the flying apparatus 100 according to an embodiment of the invention. As shown in FIG. 5, the flying apparatus 100 climbs to a certain height h from a reference surface after being activated. The height can be pre-set to be a take-off height (such as 1.5 meters) within the sensing range of the first distance sensor 130 (such as 3 meters). The first distance sensor 130 returns a distance signal to the processing module 200 according to the height h at this moment. On the other hand, the first camera unit 150 has an image-capturing area a within its view angle at the height h, and returns a surface image signal to the processing module 200 according to the image-capturing area a at this moment. Thereby, the flying apparatus 100 can complete the spatial positioning.

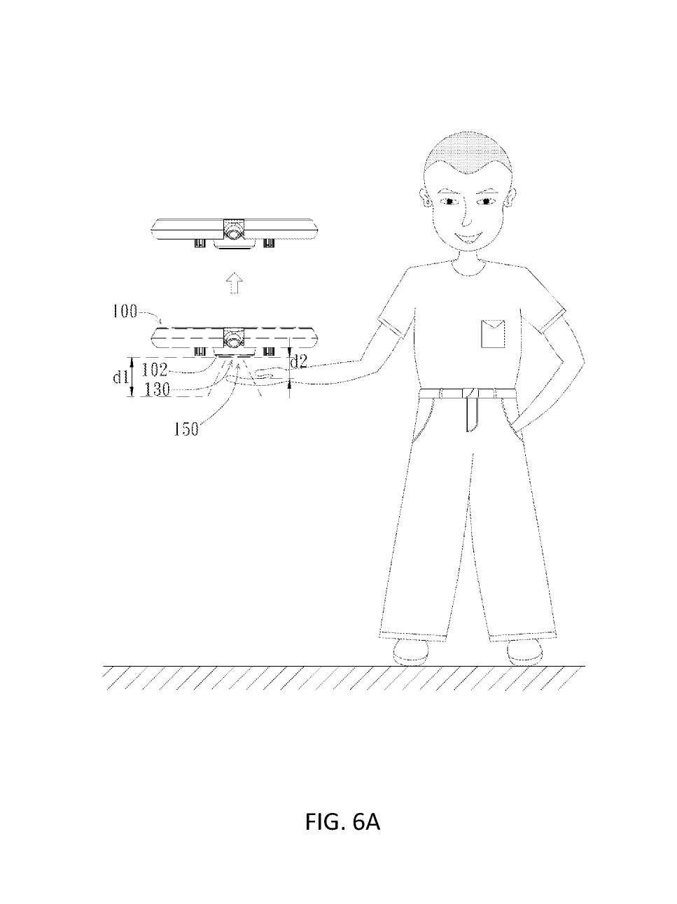

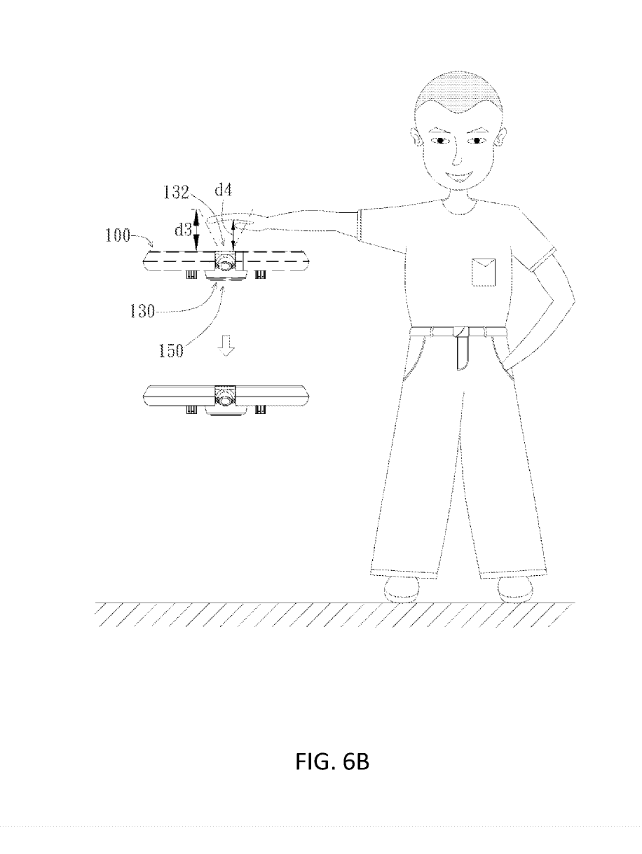

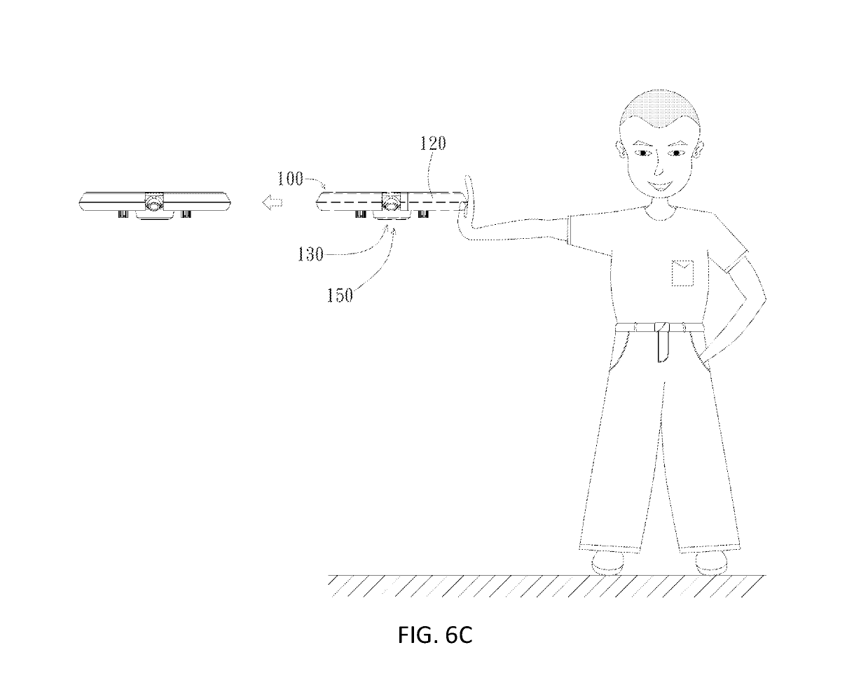

Please refer to FIG. 4 and FIG. 6A. As shown in FIG. 6A which is a schematic diagram of the operation of the flying apparatus 100, after the initial spatial positioning being completed, the flying apparatus 100 switches its signal reading mode according to its relative positional relationship with the sensed object and determines the way of receiving the sensed signal. Specifically speaking, the first distance sensor 130 has a default reception distance d1. When the first distance sensor 130 sensed that its relative distance to the sensed object is smaller than (or equal to) the default reception distance d1, the main body 102 adjusts to enter into a mode that the first distance sensor 130 performs height positioning and the first camera unit 150 performs horizontal positioning only (which mode is referred to as a first reading mode hereinbelow). To the contrary, when the first distance sensor 130 senses that its relative distance to the sensed object is longer than the default reception distance d1, the main body 102 adjusts to enter into a mode that the first distance sensor 130 performs height positioning only, and the first camera unit 150 performs horizontal positioning and motion sensing (which mode is referred to as a second reading mode hereinbelow). The sensed object is, for example, a part of a human body (such as a palm, a foot or an arm) or other object (such as an umbrella or a broom). During operation, a user can approach the distance sensor by a body part, by another object, or by a body part and another object alternately. Referring to FIG. 4, under the first reading mode, except for receiving the positioning signal mentioned previously, the processing module 200 also receives the first sensed signal 51 from the first distance sensor 130. Under the second reading mode, except for performing the positional operations via the first distance sensor 130 and the first camera unit 150, the processing module 200 receives the second sensed signal S2 from the first camera unit 150.

As shown in FIG. 6A, when the user reaches out a hand below the flying apparatus 100, the first distance sensor 130 senses that its relative distance d2 to the hand is shorter than the default reception distance d1. Accordingly, the flying apparatus 100 switches to the first reading mode. Then, when the first distance sensor 130 senses that the user's hand becomes closer, the flying apparatus 100 moves in the opposite direction (upwardly). When the flying apparatus 100 moves to the new position (as the flying apparatus shown in FIG. 6A by solid lines), it completes spatial positioning again via the first distance sensor 130 and the first camera unit 150. In other words, to avoid the flying apparatus from hitting obstacles while flying, when the flying apparatus senses that an obstacle (such as a hand) exists within the default reception distance, it automatically dodges in the opposite direction to maintain the default reception distance between itself and the obstacle. Thereby, the default reception distance can be the basis of switching the reading modes and the safety distance when the flying apparatus is flying to achieve the effect of motion sensing and flight direction changing.

Moreover, as shown in FIG. 6B, the second distance sensor 132 may also be set with a default reception distance d3, and receives the sensed signal in a way similar to that described above. What is different when compared with FIG. 6A is that when the flying apparatus 100 receives signals using the second distance sensor 132, it is easy for the user to get close to the second distance sensor 132. Therefore, the second distance sensor 132 is positioned near the hand of the sensed object, and does not suffer from the issue that the second distance sensor 132 is too far from the hand and thus do not need to perform reading mode switching with other sensing devices (such as another camera unit). When using the second distance sensor 132, the flying apparatus is maintained under the third reading mode. Referring to FIG. 4, under the third reading mode, except for performing positioning via the first distance sensor 130 and the first camera unit 150, the processing module 200 further receives the third sensed signal S3 from the second distance sensor 132. In other words, when using the second distance sensor 132, the processing module 200 does not compare the default reception distance with the relative distance but enters into the third reading mode directly. Under the third reading mode, the processing module 200 keeps performing the motion sensing via the second distance sensor 132 and uses the first distance sensor 130 and the first camera unit 150 for height positioning and horizontal positioning, respectively. However, in other embodiments, reading modes may be switched when the second distance sensor is receiving signals in view of actual requirements, and another camera unit may be added to face a direction opposite to the first camera unit for the processing module to switch between the first reading mode and the second reading mode as described previously when the sensed object appears near one side of the top surface of the main body.

As shown in FIG. 6B, when the user reaches out a hand above the flying apparatus, the second distance sensor 132 senses that its relative distance d4 to the hand is within the default reception distance d3. Then, when the second distance sensor 132 senses that the user's hand becomes closer, the flying apparatus 100 moves in the opposite direction (downwardly). When the flying apparatus 100 moves to the new position (as the flying apparatus shown in FIG. 6B by solid lines), it completes spatial positioning again via the first distance sensor 130 and the first camera unit 150. In one embodiment, the default reception distance d3 of the second distance sensor 132 is the same to the default reception distance d1 of the first distance sensor, but it is not limited therein. Thereby, the default reception distances of the first and the second distance sensors may be used together as the safety distance of the flying apparatus when flying. The effects of motion sensing and direction change of the flying apparatus can be achieved using the characteristics of the default reception distances.

Moreover, the flying apparatus can move horizontally by the pushing of the hand. As shown in FIG. 6C, when the user reaches out a hand at one side of the flying apparatus 100 to touch the external housing 120, the flying apparatus 100 moves to a new position (as the flying apparatus shown in FIG. 6C in solid lines) as the hand pushed. The spatial positioning is completed again by the first distance sensor 130 and the first camera unit 150.

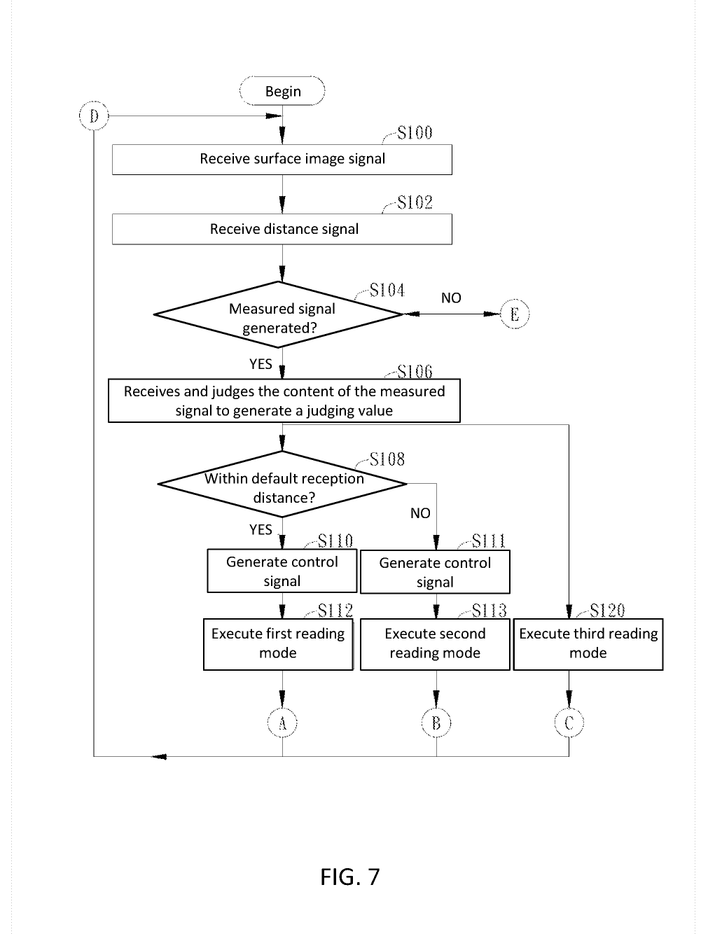

FIG. 7 is a flowchart of the method of remotely controlling a flying apparatus according to an embodiment of the invention. As shown in FIG. 7, the method of remotely controlling a flying apparatus includes steps S100˜S113. In S100, the processing module receives surface image signals from the first camera unit. In S102, the processing module receives the distance signal from the first distance sensor. In S104, the processing module determines whether the measured signal is generated. When the processing module receives the measured signal, the process then proceeds to S106. In S106, the processing module receives and judges the content of the measured signal to generate a judging value. For example, the measured signal may come from the first distance sensor (the first situation) or the second distance sensor (the second situation). Under the first situation, the first distance sensor generates the measured signal according to its relative position to the sensed object and outputs the measured signal to the processing module. The processing module then generates the judging value and outputs the judging value to the switching module to determine whether to enter into the first reading mode or the second reading mode (to proceed to S108). Under the second situation, the second distance sensor generates the measured signal according to its relative position to the sensed object and outputs the measured signal to the processing module. The processing module then generates the judging value to enter into the third reading mode (to proceed to S120). From the above, it can be understood that the source and content of the measured signal are the basis of switching between different reading modes. For example, the measured signal may represent the relative distance between the sensed object and the first distance sensor (or the second distance sensor) using the first distance sensor (or the second distance sensor).

As mentioned above, the first distance sensor includes a default reception distance. The default reception distance can be compared with the relative distance represented by the measured signal to perform the switch of the reading modes. In S108, the switching module generates different control signals according to whether the sensed object falls within the default reception distance based on the judging value. In detail, if the relative distance is shorter than or equal to the default reception distance, the control signal from the switching module makes the main body enter into the first reading mode; if the relative distance is longer than the default reception distance, the control signal from the switching module makes the main body enter into the second reading mode. Corresponding to the embodiment described previously, in S110 and S112, when the sensed object falls within the default reception distance, the processing module adjusts the main body to the first reading mode according to the control signal received from the switching module. To the contrary, in S111 and S113, when the sensed object does not fall within the default reception distance, the processing module adjusts the main body to the second reading mode according to the control signal received from the switching module.

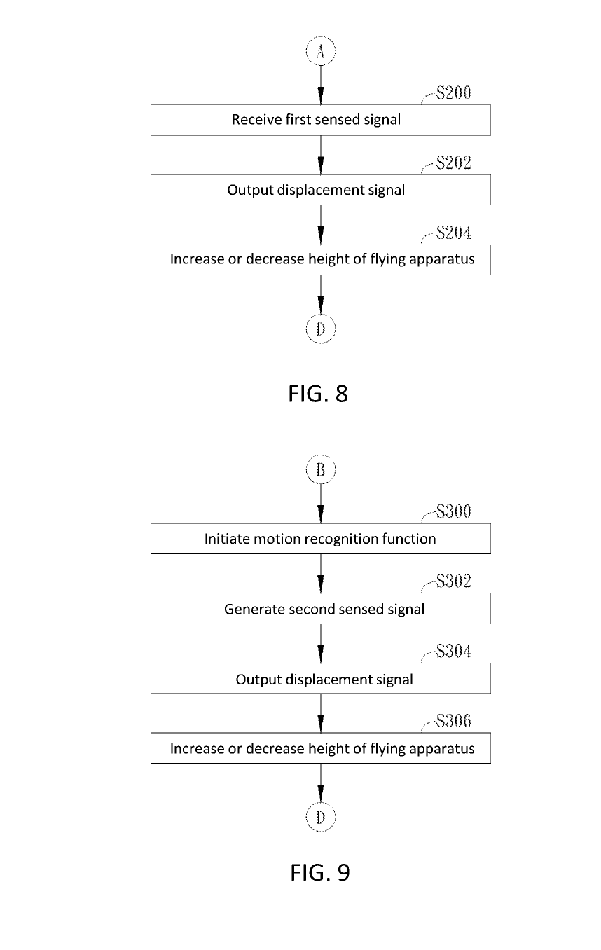

FIG. 8 is a flowchart showing an embodiment of the first reading mode. As shown in FIG. 8, the operation of the first reading mode includes steps S200 to S204. In S200, the processing module receives the first sensed signal from the first distance sensor. In S202, the processing module outputs a displacement signal according to the first sensed signal to the flight driving module. The flight driving module controls the rotation speeds of the rotors to change the moving direction of the flying apparatus. In S204, after receiving the displacement signal, the flight driving module increases or decreases the height of the flying apparatus according to the displacement signal.

FIG. 9 is a flowchart showing an embodiment of the second reading mode. As shown in FIG. 9, the operation of the second reading mode includes steps S300 to S306. In S300, the first camera unit initiates the motion recognition function according to the second reading mode. In S302, the first camera unit captures the gesture of the user to generate the second sensed signal and output the second sensed signal to the processing module. In S304, the processing module receives the second sensed signal and outputs the displacement signal to the flight driving module according to the content of the second sensed signal. In S306, after receiving the displacement signal, the flight driving module increases or decreases the height of the flying apparatus according to the displacement signal. In other embodiment, the processing module can use the second distance sensor to increase or decrease the height of the flying apparatus. As mentioned previously, when using the second distance sensor, the sensing operation can be performed directly without the comparison of the relative distance according to practical needs. Similar to the sensing operation under the first reading mode, the operation of the third reading mode can include steps S230 to S234. In S230, the processing module receives the third sensed signal from the second distance sensor. In S232, the processing module receives the third sensed signal and outputs the displacement signal to the flight driving module according to the third sensed signal. In S234, the movement of the flying apparatus is changed by the flight driving module.

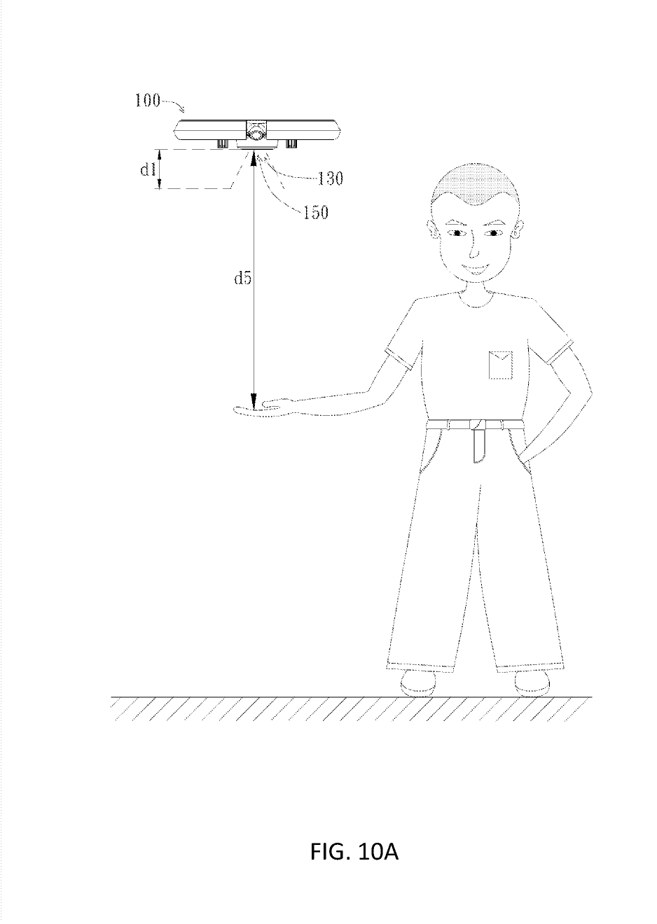

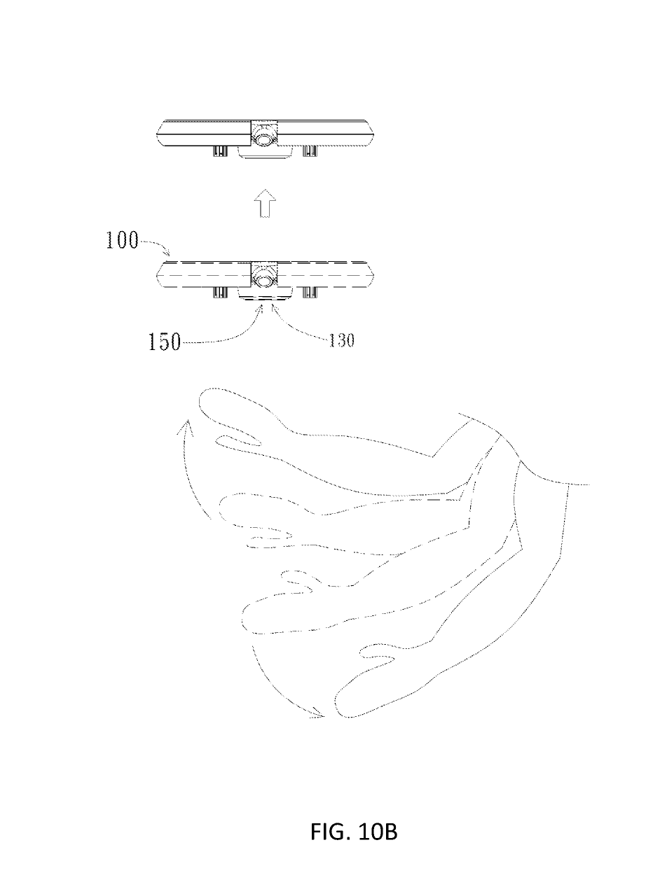

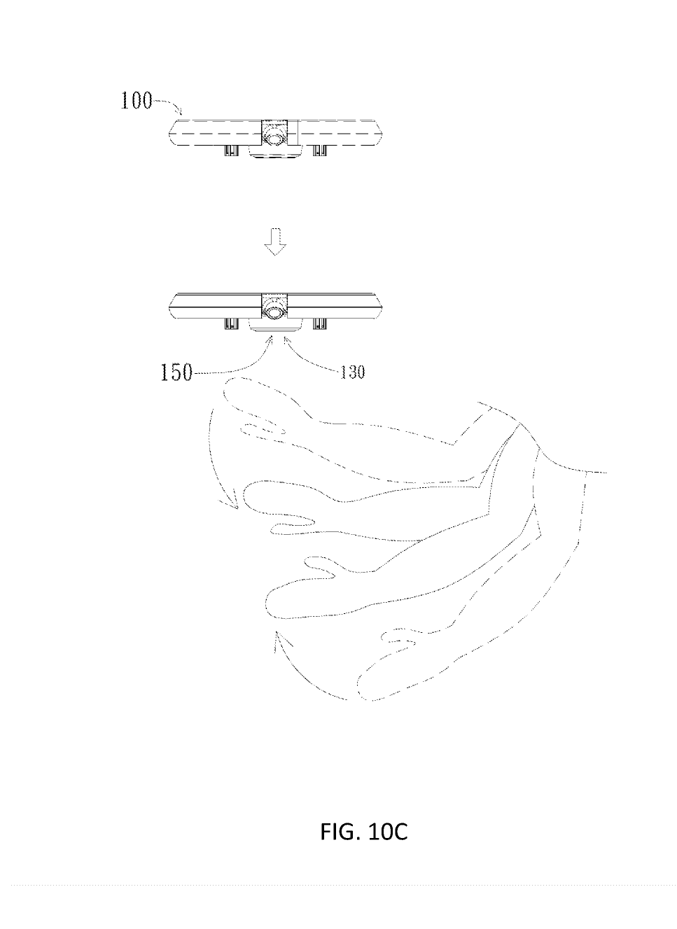

FIG. 10A to FIG. 10C depicts the operation of the flying apparatus under the second reading mode. As shown in FIG. 10A, when the user reaches out the hand under the flying apparatus 100, the first distance sensor 130 senses the relative distance d5 between the first distance sensor 130 and the hand, and the relative distance d5 is longer than the default reception distance d1. Accordingly, the flying apparatus 100 switches to the second reading mode to receive the sensed signal from the first camera unit 150. Specifically speaking, the first camera unit 150 can recognize the height-increasing gesture and the height-decreasing gesture of the user. For example, to open the arm means to increase the height of the flying apparatus, and to close the arm means to decrease the height of the flying apparatus. As shown in FIG. 10B, after the gesture recognition function is activated, when the user performs an arm-opening gesture below the first camera unit 150, the first camera unit 150 captures the gesture to generate the second sensed signal and output it to the processing module. After moving to a new position (as the flying apparatus shown FIG. 10B by solid lines) from its original position (as shown by dotted lines) according to the operation described above, the flying apparatus 100 completes spatial positioning via the first distance sensor 130 and the first camera unit 150. To the contrary, as shown in FIG. 10C, when the user performs an arm-closing gesture below the first camera unit 150, the first camera unit 150 captures the gesture to generate the second sensed signal and output it to the processing module. After moving to a new position (as the flying apparatus shown FIG. 10C by solid lines) from its original position (as shown by dotted lines) according to the operation described above, the flying apparatus 100 completes spatial positioning via the first distance sensor 130 and the first camera unit 150 again. Thereby, the motion sensing and the direction changing of the flying apparatus can be achieved by the cooperation of the gesture and the first camera unit.

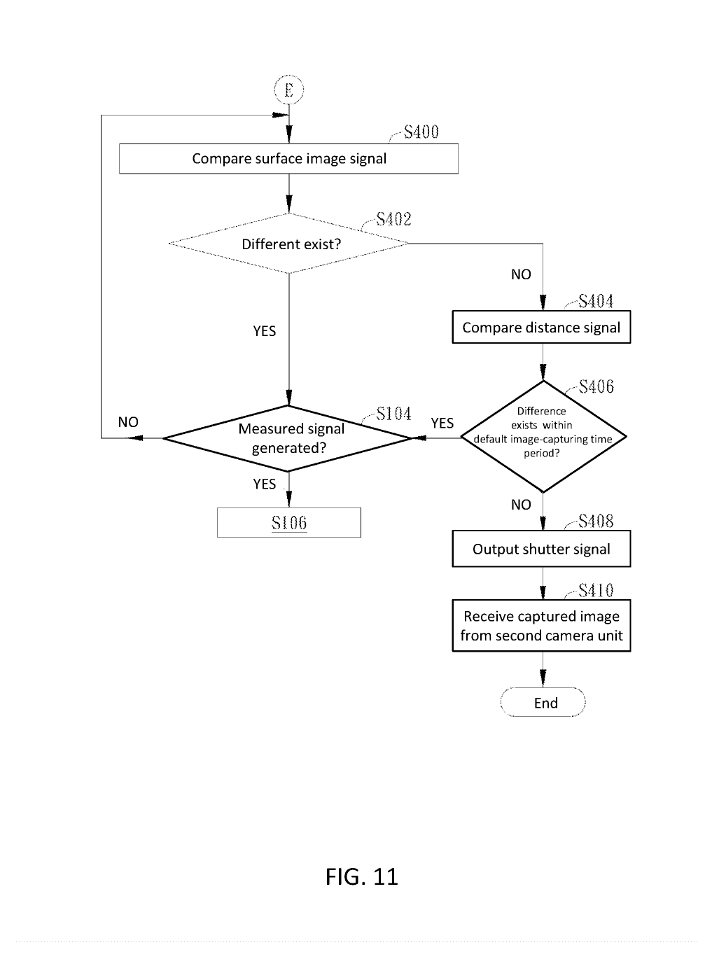

As described above, every time when the motion sensing is completed (return to node D), the flying apparatus moves to a new position. Referring to FIG. 7, the flying apparatus also performs spatial positioning using the first distance sensor and the first camera unit at the new position. An image-capturing activity can be performed once the moving of the flying apparatus is completed. As shown in FIG. 7, in S104, when the processing module does not receive the measured signal, the process proceeds from node E to S400 to compare the surface image signal with the distance signal. In other words, the method for the flying apparatus to perform automatic image capturing can be set by using the processing module to perform the comparisons of the surface image signals and the distance signals. Referring to FIG. 11, which is a flowchart showing the generation of the captured image by the method of remotely controlling a flying apparatus according to an embodiment of the invention. As shown in FIG. 11, the method of remotely controlling a flying apparatus includes steps S400 to S410. In S400 to S402, the processing module compares the surface image signals and judges whether any difference exists. In S404 to S406, the processing module then compares the distance signals and judges whether any difference exists. Specifically speaking, the processing module is set with a default image-capturing time period (such as 10 seconds), and the judgments of the surface image signals and the distance signals are judging whether any variation exists within 10 seconds. In S406, it is judged whether any difference exists within the default image-capturing time period. Based on the embodiment above, if it is judged that a difference exists within 10 seconds, the process returns to S104 to see whether any new measured signal is generated. If a new measured signal is generated, the process of sensing and increasing or decreasing the height of the flying apparatus is performed. If no new measured signal is generated, the processing module re-performs the comparisons of the surface image signals and the distance signals. To the contrary, if it is judged that no difference exists within 10 seconds, the processing module outputs a shutter signal to the second camera unit (S408). In S410, the second camera unit performs image capturing and returns the captured image. After receiving the captured image from the second camera unit, the processing module can further store the captured image in the storage module.

FIG. 12 is a schematic diagram showing the generation of the captured image. As shown in FIG. 12, after the flying apparatus 100 being moved to the required position for a time period, the processing module judges that no difference exists among the surface image signals and the distance signals received within the default image-capturing time period. Then, the processing module outputs the shutter signal to the second camera unit 152 to capture an image using the second camera unit 152. By using the default image-capturing time period as the threshold value of comparing the surface image signals and the distance signals, the timer image-capturing function is achieved. Therefore, the user can capture image using the flying apparatus with the motion-sensing design without additional equipment or device, while at the same time the complexity of operating the flying apparatus can be simplified.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A flying apparatus, comprising:
a main body, including:
a top surface;
a bottom surface;
a processing module for outputting a displacement signal according to a first sensed signal;
a flight driving module for receiving the displacement signal and increasing or decreasing the height of the flying apparatus according to the displacement signal;
a first distance sensor disposed at the bottom surface of the main body for sensing a relative distance to a sensed object and outputting the first sensed signal when the relative distance is shorter than a default reception distance; and
a second distance sensor disposed at the top surface of the main body for sensing the relative distance to the sensed object and outputting the first sensed signal when the relative distance is shorter than the default reception distance.

2. The flying apparatus according to claim 1, further comprising:
a plurality of first arms, each of the first arms having one end connected with the main body and extending from the main body; and
at least one external housing disposed around the main body and connected with the first arms.

3. The flying apparatus according to claim 2, further comprising:
a second arm connected with the main body along a radial direction;
a first camera unit connected with the second arm and disposed toward the direction of the bottom surface; and
a third arm connected with the main body along the radial direction opposite to the second arm.

4. The flying apparatus according to claim 3, wherein the first camera unit outputs a second sensed signal, the processing module outputs the displacement signal according to the second sensed signal, and the flight driving module increases or decreases the height of the flying apparatus according to the displacement signal.

5. The flying apparatus according to claim 2, wherein the external housing further comprises:
a rotatable part having two side plates and a connecting plate connecting the two side plates, a pivot is formed at the two side plates respectively so that the rotatable part is rotatably connected to the external housing; and
a second camera unit disposed at the outer surface of the connecting plate.

6. The flying apparatus according to claim 2, further comprising a plurality of rotors disposed at the first arms and within the external housing.

7. The flying apparatus according to claim 1, wherein the first distance sensor generates a measured signal according to the relative positional relationship to the sensed object, and the processing module judges the content of the measured signal to generate a judging value, the main body further comprises:
a switching module for receiving the judging value to generate a control signal, the processing module switching to a first reading mode or a second reading mode according to the control signal.

8. A method of remotely controlling a flying apparatus for the flying apparatus claimed in claim 7, the method of remotely controlling a flying apparatus comprising the steps of:
obtaining the relative distance between the first distance sensor and the sensed object by the first distance sensor;
comparing the relative distance with the default reception distance;
entering into the first reading mode if the relative distance is shorter than or equal to the default reception distance, wherein in the first reading mode the first distance sensor performs height positioning and motion sensing, the first camera unit performs horizontal positioning; and
entering into the second reading mode if the relative distance is longer than the default reception distance, wherein in the second reading mode the first distance sensor performs height positioning, the first camera unit performs horizontal positioning and motion sensing.

9. The method of remotely controlling a flying apparatus according to claim 8, wherein when executing the first reading mode, the method of remotely controlling a flying apparatus further comprises:
receiving the first sensed signal from the first distance sensor;
outputting the displacement signal according to the first sensed signal; and
receiving the displacement signal and increasing or decreasing the height of the flying apparatus according to the displacement signal.

10. The method of remotely controlling a flying apparatus according to claim 8 wherein the processing module has a motion recognition function, when executing the second reading mode, the method of remotely controlling a flying apparatus further comprises:
initiating the motion recognition function;
capturing the gesture of the sensed object by the first camera unit to generate the second sensed signal;
receiving the second sensed signal and outputting the displacement signal according to the second sensed signal; and
receiving the displacement signal and increasing or decreasing the flying apparatus according to the displacement signal.

11. The method of remotely controlling a flying apparatus according to claim 8, wherein the first distance sensor can receive a distance signal, the first camera unit can receive a surface image signal, and the processing module has a default image-capturing time period, the method of remotely controlling a flying apparatus further comprises:
outputting a shutter signal when both the surface image signals and the distance signals have no difference within the default image-capturing time period; and
receiving a captured image from the second camera unit.

12. The method of remotely controlling a flying apparatus according to claim 8, wherein the flying apparatus can enter into a third reading mode by the second distance sensor, in the third reading mode the first distance sensor performs height positioning, the second distance sensor performs motion sensing, the first camera unit performs horizontal positioning, when executing the third reading mode the method of remotely controlling a flying apparatus further comprises:
receiving the third sensed signal;
outputting the displacement signal according to the content of the third sensed signal; and
receiving the displacement signal and increasing or decreasing the height of the flying apparatus according to the displacement signal.
